(19) United States
(12) Patent Application Publication
(10) Pub. No.: US 2022/0007670 A1
(43) Pub. Date: Jan. 13, 2022

(54) MENTHA EXTRACTION AND INFUSION

(71) Applicant: Bryan St. Clair, College Park, MD (US)

(72) Inventor: Bryan St. Clair, College Park, MD (US)

(21) Appl. No.: 17/068,101

(22) Filed: Oct. 12, 2020

Related U.S. Application Data
(60) Provisional application No. 62/913,275, filed on Oct. 10, 2019.

(51) Int. Cl. A23F 3/34; B01D 11/02

(52) U.S. Cl. CPC A23F 3/34; B01D 11/0288

(57) ABSTRACT

A method for extracting and infusing Mentha by mixing sugar, Mentha and water, heating to a temperature of between 128 degrees and 143 degrees Fahrenheit (F) for four minutes, extracting any of menthone, menthol, and methyl acetate, filtering the extracted constituent, and combining the filtered constituent with a liquid composition comprising an alcohol.

### CROSS-REFERENCE TO RELATED APPLICATIONS

The present application derives priority from U.S. Provisional Application Ser. No. 62/913,275 filed 10 Oct. 2019.

### BACKGROUND OF THE INVENTION

### Field of the invention

The present invention relates to extraction of mint essential oil (Mentha).

### Description of the Background

Mentha (also known as mint) is a genus of plants in the family Lamiaceae (mint family). Some species such as spearmint (Mentha spicata L.) and peppermint (Mentha piperita L.) have important biological activities and are commonly consumed as herbal teas. Pressurized hot water extraction (PHWE) has become a popular extraction method for different compounds present in environmental, food and botanical samples. PHWE is also used to extract organic contaminants from foodstuff. However, the effectiveness of PHWE extraction for any given compound is highly dependent on applied temperature and other variables. With some modifications, a scaled-up PHWE could extract a higher amount of desirable compounds from Mentha.

### BRIEF DESCRIPTION OF THE DRAWINGS

FIG. 1 shows a flow diagram of an example procedure for extracting and infusing Mentha, according to embodiments of this disclosure.

FIG. 2 shows examples of Mentha compounds, according to embodiments of this disclosure.

FIG. 3 shows examples of equipment for extracting and infusing Mentha, according to embodiments of this disclosure.

### DETAILED DESCRIPTION

Embodiments of this disclosure include a procedure or method for extracting and infusing Mentha. The procedure can include, for example, heating a mixture, which includes a sugar composition, a Mentha composition, and water to approximately 143 degrees Fahrenheit (F). The procedure can include extracting at least one Mentha compound selected from a group consisting of menthone, menthol, and methyl acetate from the Mentha composition. Mentha compounds may be extracted by, for example, maintaining the mixture at a temperature no greater than approximately 143 degrees F. and no less than approximately 128 degrees F. for approximately 4 minutes. The procedure can also include filtering the mixture to remove the Mentha composition and further extracting Mentha compounds by, for example, applying pressure to the removed Mentha composition to extract Mentha fluid that includes one or more Mentha compounds. The procedure may also include combining the filtered mixture, the extracted Mentha fluid, and a liquid composition comprising an alcohol, and cooling the combined liquid composition. The cooled, combined liquid composition may be a mixed alcoholic drink suitable for serving, such as a mint julep.

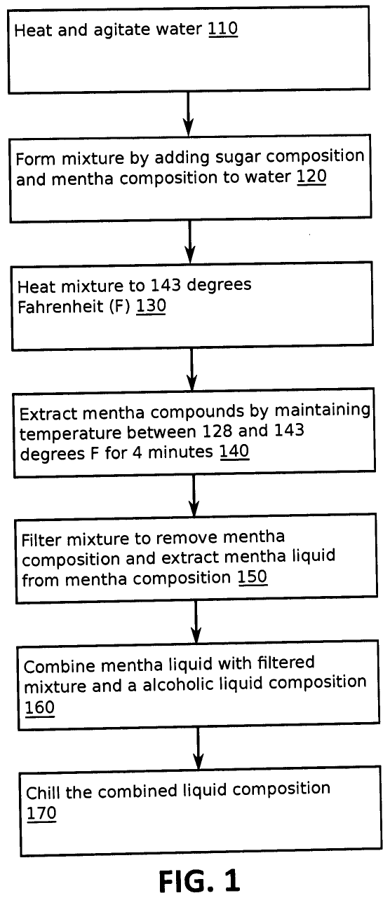

Various procedures can be performed to extract and infuse Mentha, according to embodiments of this disclosure. For example, FIG. 1 shows a flow diagram of an example procedure for extracting and infusing Mentha. A heating device, such as stove top, water boiler, or other device suitable for the purposes of this disclosure can apply heat to a volume of water, and a suitable agitation device such as a mixer or whisk, can agitate the water at 110. A sugar composition and Mentha composition can be added to the water at 120 to form a mixture. The sugar composition can be, for example, any one or more of molasses, sorghum syrup, maple syrup, corn syrup, invert syrup, glucose, fructose, galactose, sucrose, lactose, and maltose. The Mentha composition can include one or more species of the genus Mentha and/or hybrids of the genus Mentha. For example, the Mentha composition can include any one or more of water mint, corn mint, Australian mint, American wild mint, Hart's pennyroyal, pennyroyal mint, native pennyroyal, Dahurian thyme, slender mint, forest mint, horse mint, Corsican mint, spearmint, apple mint, peppermint, gingermint, false apple mint, large apple mint, sharp-toothed mint, and red raripila mint. In some embodiments the Mentha composition can include fresh Mentha species and/or hybrids. In other embodiments, the Mentha composition can include dried Mentha species and/or hybrids, or both fresh and dry Mentha species and/or hybrids.

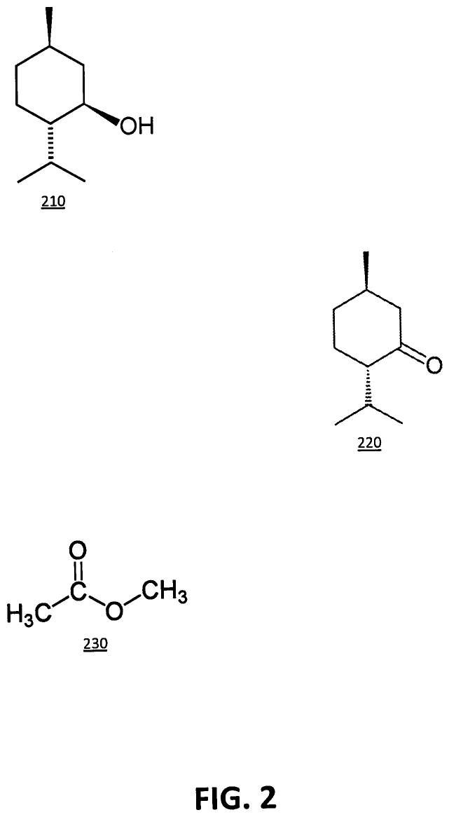

The mixture can be heated to approximately 143 degrees F., according to embodiments of this disclosure at 130. With respect to temperature, “approximately” may mean plus/minus up to two degrees F. The mixture can continue to be agitated while being heated to 143 degrees F. However, in some embodiments it is critical that the mixture not be heated to above 143 degrees F. as the mixture in such embodiments may boil above 143 degree F. Generally, the mixture will not reach its boiling point, according to embodiments of this disclosure. At 140 the temperature of the mixture can be maintained between approximately 128 degrees F. and approximately 143 degrees F. for approximately four minutes. With respect to such time values, “approximately” may mean plus/minus up to two minutes. Generally, procedures according to embodiments of this disclosure will prevent crystals from forming in the mixture. Crystals may include sugar crystals and/or crystals that include any of the Mentha compounds discussed below with respect to FIG. 2. In some embodiments it will be critical to prevent the temperature of the mixture from dropping below 128 degrees F. to prevent crystals from forming in the mixture. In some embodiments the mixture may be heated for two additional minutes and/or agitated throughout or selectively during the heating process.

By maintaining the mixture between approximately 128 degrees F. and approximately 143 degrees F. for approximately four minutes, Mentha compounds discussed below can be extracted from the Mentha composition. For example, chemical bonds securing the Mentha compounds within the Mentha composition can be broken, by heating the mixture, and the Mentha compounds can thereby be released into the mixture. The mixture can be filtered to separate the Mentha composition from the remainder of the mixture and additional Mentha compounds can be extracted from the Mentha composition at 150. For example, a screen, perforated vessel, or other suitable device can be applied to the mixture to strain the mixture and separate and removed the Mentha composition. The removed Mentha composition can be placed in a woven textile, such as a cheesecloth, a metal or plastic sieve or screen, or any other device suitable for the purposes of this disclosure and pressure can be applied to the Mentha composition to extract Mentha fluid. Pressure can be applied, for example, by a press or manual pressure, or any other pressure device suitable for the purposes of this disclosure for between one and four times. In some embodiments, the pressure may be applied five or more times. The extracted Mentha fluid may include additional Mentha compounds to be added back to the filtered mixture.

The Mentha fluid can be combined with the filtered mixture and an alcoholic liquid composition and thereby form a infused and combined alcoholic liquid composition at 160. The alcoholic liquid composition can include any alcoholic liquid suitable for the purposes of this disclosure. For example, the alcoholic liquid composition can include any one or more of absinthe, baijiu, brandy, gin, pisco, rum, schnapps, tequila, mezcal, vodka, and whiskey, such as rye whiskey or bourbon whiskey. In some embodiments, the quantity of the alcoholic liquid composition can be approximately 59.2 fluid ounces, where “approximately” can mean plus/minus up to five percent of the quantity specified, in this case, 59.2 fluid ounces.

The relative volumes of water, sugar composition, Mentha composition, and alcoholic liquid composition can be any relative volumes suitable for the purposes of this disclosure. For example, a ratio by volume of the sugar composition to the water in the mixture can be approximately two to approximately one. As another example, a ratio by volume of the fresh Mentha composition to water in the mixture can be approximately three to approximately one. As another example, the liquid composition can be approximately 40 percent alcohol by volume and the combined liquid composition can be between approximately 30 percent to approximately 35 percent alcohol by volume. With respect to a number in a ratio or percentage, “approximately” can mean plus/minus up to five percent of the total quantity to which the ratio is applied.

The combined Mentha fluid, filtered mixture, and alcoholic liquid composition can be cooled at 170. For example, the combined liquid composition can be chilled in a freezer or other suitable cooling device at or below zero degrees F. for approximately eight hours, where “approximately” can mean plus/minus up to two hours. Generally, the combined liquid composition will not be cooled to the degree that it freezes solid. In some embodiments, the combined liquid composition can be further agitated for up to fifteen minutes before cooling.

Various compounds can be extracted from Mentha compositions and used in infusions, according to embodiments of this disclosure. For example, FIG. 2 shows Mentha compounds that can be extracted from Mentha compositions. For example, a Mentha compound can include menthol 210, having International Union of Pure and Applied Chemistry (IUPAC) name 5-Methyl-2-(propan-2-yl)cyclohexan-1-ol and molecular formula C10H20O. As another example, a Mentha compound can include Menthone 220, having IUPAC name (2S,5R)-5-methyl-2-propan-2-ylcyclohexan-1-one and molecular formula C10H18O. As another example, a Mentha compound can include a menthone, and methyl acetate 230, having molecular formula C3H6O2. A Mentha compound or combinations of Mentha compounds may be extracted and infused, according to embodiments of this disclosure.

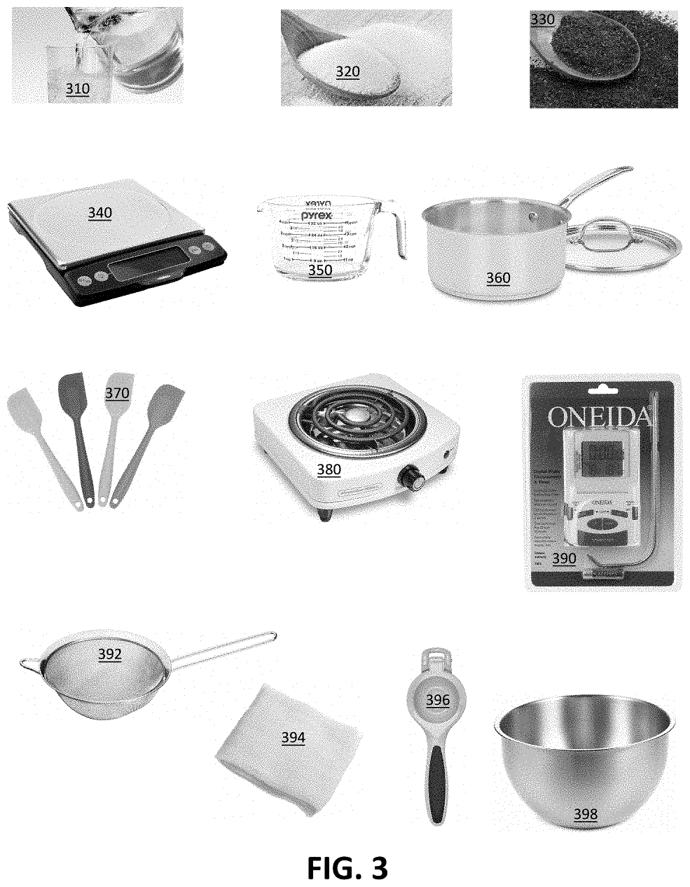

Various types of equipment can be used to extract and infuse Mentha, according to embodiments of this disclosure. For example, FIG. 3 shows equipment for extracting and infusing Mentha. Water 310, a sugar composition that includes sugar 320, and a Mentha composition that includes ground peppermint 330 can be measured using scale 340 and/or measuring cup 350 and combined into a mixture in a container, such as saucepan 360. The mixture can be agitated using agitating devices, such as silicon spatulas 370. A heating device, such as electric heat source 380 can be used to heat the mixture, and thermometer 390 can determine the temperature of the mixture to maintain the mixture within acceptable ranges in accordance with this disclosure. The mixture can be filtered to remove the Mentha composition using a filter device, such as mesh strainer 392. The removed Mentha composition can be contained in a textile, such as cheesecloth 394 and pressed using press 396 to extract additional Mentha fluid. The extracted Mentha fluid can be combined with the mixture and an alcoholic liquid composition in bowl 398 into a combined liquid composition.

For the purposes of this disclosure, unless expressly stated otherwise: (a) the use of singular forms of terms include plural forms; (b) the use of the terms “including,” “having,” and similar terms are deemed to have the same meaning as “comprising” and thus should not be understood as limiting; (c) the term “set” or “subset” means a collection of one or more than one elements; (d) the term “plurality” means a collection of two or more elements; (e) the term “such as” means for example; (f) the term “and/or” means any combination or sub-combination of a set of stated possibilities, for example, “A, B, and/or C,” means any of: “A,” “B,” “C,” “AB,” “AC,” or “ABC;” and (g) headings, numbering, bullets, or other structuring of the text of this disclosure is not to be understood to limit or otherwise affect the meaning of the contents of this disclosure.

The foregoing disclosure, for purpose of explanation, has been described with reference to specific embodiments. The illustrative discussions above are not intended to be exhaustive or to limit embodiments of the disclosure to the precise forms disclosed. Embodiments of this disclosure may include combinations or arrangements of multiple embodiments or portions of embodiments of this disclosure in any manner suitable for the purposes of this disclosure. Many modifications and variations are possible in view of the teachings of this disclosure. The embodiments were chosen and described in order to explain the principles of embodiments of the disclosure and their practical applications, and to thereby enable others skilled in the art to utilize those embodiments as well as various embodiments with various modifications as may be suited to the particular use contemplated.

I claim:

1. A method for infusing Mentha extracts, comprising the steps of:
mixing sugar, Mentha and water;
heating said sugar, Mentha and water composition to a temperature of between 128 degrees and 143 degrees Fahrenheit (F);
maintaining said temperature for four minutes;
extracting at least one constituent from said heated said sugar, Mentha and water composition, said constituent from among a group consisting of menthone, menthol, and methyl acetate;
filtering the extracted constituent; and
combining the filtered constituent with a liquid composition comprising an alcohol.

2. The method of claim 1, further comprising a step of applying pressure to said sugar, Mentha and water composition.

3. The method of claim 2, further comprising a step of pressing said sugar, Mentha and water over a woven textile between one and four times.
